(19) United States
(12) Patent Application Publication
(10) Pub. No.: US 2006/0015210 A1
(43) Pub. Date: Jan. 19, 2006

(54) Method for adjusting display parameters of a display device

(75) Inventor: Shih-Hua Tseng, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/146,049

(22) Filed: Jun. 7, 2005

(30) Foreign Application Priority Data
Jul. 15, 2004 (TW) 093121103

(51) Int. Cl. G06F 19/00

(52) U.S. Cl. 700/170; 700/95

(57) ABSTRACT

A method for adjusting display parameters of a display device is disclosed. The display parameters can be displayed on an engineering OSD interface or a user OSD interface, and therefore the user can modify some of the display parameters opened to the user and the engineer can modify all of the display parameters. Wherein the engineering OSD interface is called up by pressing a hot key, and the hot key includes a power button and an adjusting button, or a plurality of adjusting buttons.

### BACKGROUND OF THE INVENTION

1. Field of the Invention

The present invention relates to a method for adjusting display parameters of a display device.

2. Description of the Related Art

As shown in FIG. 1, a display device 10 (such as a CRT display device or an LCD display device) comprises a power button 12 and several adjusting buttons 14 disposed on the surface of the display device 10, a microprocessor 16 and a memory. The power button 12 is used for turning the display device 10 on or off. The adjusting buttons 14 are used for recalling an OSD (on-screen display) interface and adjusting display parameters of the display device 10 which are opened for the user to adjust display parameters such as brightness, contrast, position, scale, size, and so on. The memory 18 is used to store the display parameters, including the display parameters opened and not opened to the user, and a firmware program. The microprocessor 16 reads and executes the firmware program stored in the memory 18, and reads the display parameters stored in the memory 18 according to the firmware program, so as to adjust the image displayed on the display device 10.

Furthermore, in order to avoid the user incorrectly adjusting the display parameters, and to code one same firmware program capable of fitting diverse types of display device 10, the manufacturer must set up some values of the display parameters which are not opened to the user, including: a parameter for switching to a warm-up mode or a debug mode, a parameter for enabling or disabling the audio device. However, after the above-mentioned parameters are stored in the memory 18, these parameters can only be adjusted when the display device 10 is sent back to the manufacturer. If the parameters are just absent or need to be modified, it is very inconvenient for the maintenance engineer at the retailer to adjust the display device 10.

Therefore, it is desirable to provide a method for adjusting display parameters of the display device 10 to mitigate and/or obviate the aforementioned problems.

### BRIEF SUMMARY OF THE INVENTION

Accordingly, an embodiment of the present invention is directed to a method that allows the user or the engineer to adjust the display parameters respectively.

To achieve the advantage, and in accordance with the purpose of the present invention as embodied and broadly described, there is provided a method for adjusting display device parameters of a display device, which comprises: (A) determining whether an engineering OSD interface is recalled; (B) adjusting and storing the display parameters displayed on the engineering OSD interface; and (C) adjusting and storing the display parameters displayed on the user OSD interface; wherein the engineering OSD interface is recalled by pressing a hot key, and the display parameters include the display parameters displayed on the engineering OSD interface and the user OSD interface.

Also in accordance with the present invention, there is provided a method for adjusting display device parameters of a display device, which comprises: (A) recalling a user OSD interface; (B) determining whether an engineering OSD interface is recalled; (C) adjusting and storing the display parameters displayed on the user OSD interface; and (D) adjusting and storing the display parameters displayed on the user OSD interface; wherein the display device parameters include the manufacturer setting parameters and the user setting parameters.

Additional features and advantages of the present invention will be set forth in part in the description which follows, and in part will be obvious from the description, or may be learned by practice of the present invention. The features and advantages of the present invention will be realized and attained by means of the elements and combinations particularly pointed out in the henceforth appended claims.

It is to be understood that both the foregoing general description and the following detailed description are exemplary and explanatory only and are not restrictive of the present invention, as claimed.

The accompanying drawings, which are incorporated in and constitute a part of this specification, illustrate several embodiments of the present invention and together with the description, serve to explain the principles of the present invention.

### BRIEF DESCRIPTION OF THE DRAWINGS

FIG. 1 is a schematic drawing of a display device;

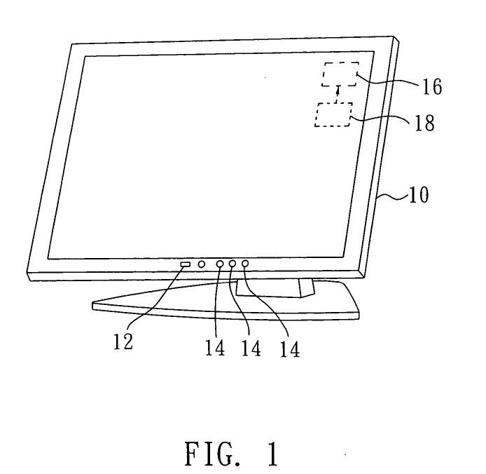

FIG. 2 is a flowchart of a first embodiment of a method for adjusting display parameters of a display device according to the present invention; and

FIG. 3 is a flowchart of a second embodiment of a method for adjusting display parameters of a display device according to the present invention.

### DESCRIPTION OF THE EMBODIMENTS

Reference will now be made in detail to present embodiments of the present invention, examples of which are illustrated in the accompanying drawings. Wherever possible, the same reference numbers will be used throughout the drawings to refer to the same or like parts.

In the present invention, a user can press various adjusting buttons 14 of the display device 10 at the same time to recall a user OSD interface or an engineering OSD interface to adjust the display parameters opened to the user or the display parameters opened to the engineer (not opened to the user) respectively. The adjusting buttons 14 can be pressed while the display device 10 is turned on or while the display device 10 is operating.

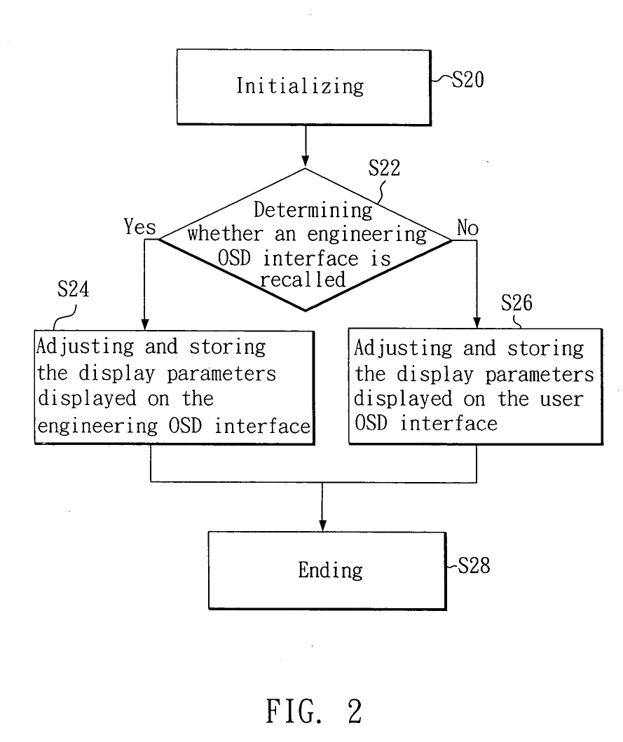

As shown in FIG. 2, the method for adjusting display parameters of the first embodiment of the display device 10 in accordance with the invention comprises:

Step S20: Initializing. When the power button 12 is pressed, the display device 10 executes an initialization procedure.

Step S22: Determining whether an engineering OSD interface is recalled; if not, step S26 is performed. A user can recall the engineering OSD interface by pressing hot keys. For example, by pressing at least two adjusting buttons 14, or by pressing both the power button 12 and the adjusting button 14. Or, the user may input a password to recall the engineering OSD interface. For example, when the user presses the adjusting buttons 14, a message requiring a password is displayed; if the user does not key-in the correct password, the microprocessor 16 recalls the user OSD interface; if the user inputs the correct password, the microprocessor 16 recalls the engineering OSD interface.

Step S24: Adjusting and storing the display parameters displayed on the engineering OSD interface, and then step S28 is executed. After the engineering OSD interface is called up, engineers can modify the display parameters opened to the engineer and then store the modified display parameters into the memory 18.

Step S26: Adjusting and storing the display parameters displayed on the user OSD interface. After the user OSD interface is called up, the user can modify the display parameters opened to the user, i.e., the user setting parameters, and then store the modified display parameters into the memory 18.

Step S28: End.

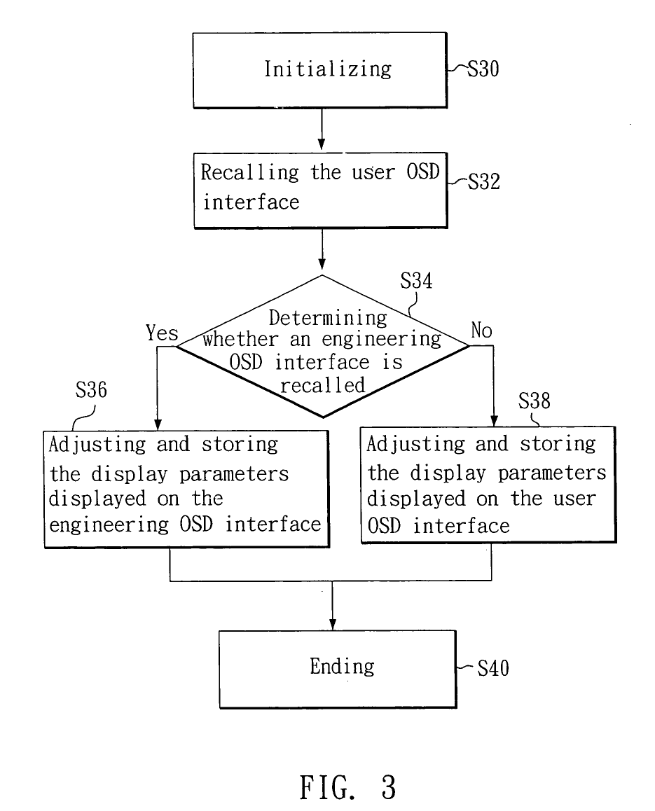

As shown in FIG. 3, the method for adjusting display parameters of the second embodiment of the display device 10 in accordance with the invention comprises:

Step S30: Initializing. When the power button 12 is pressed, the display device 10 executes an initialization procedure.

Step S32: Recalling the user OSD interface. When the user presses the adjusting button 14, the user OSD interface is called up and displayed on the display device 10, and so the user or engineer can adjust display parameters opened to the user, i.e., the user setting parameters.

Step S34: Determining whether an engineering OSD interface is recalled; if not, step S38 is performed. The engineer can recall the engineering OSD interface by pressing hot keys. For example, by pressing at least two adjusting buttons 14, or by pressing both the power button 12 and the adjusting button 14. Or, the user may input a password to recall the engineering OSD interface. For example, when the user presses the adjusting buttons 14, a message requiring a password is displayed; if the user does not key-in the correct password, the microprocessor 16 recalls the user OSD interface; if the user inputs the correct password, the microprocessor 16 recalls the engineering OSD interface.

Step S36: Adjusting and storing the display parameters displayed on the engineering OSD interface, and step S40 is executed. After the engineering OSD interface is called up, engineers can modify the display parameters opened to the engineers, i.e., the manufacturer setting parameters, and then store the modified display parameters into the memory 18.

Step S38: Adjusting and storing the display parameters displayed on the user OSD interface. After the user OSD interface is called up, the user can modify the display parameters opened to the user, i.e., the user setting parameters, and then store the modified display parameters into the memory 18.

Step S40: End.

Other embodiments of the present invention will be apparent to those skilled in the art from consideration of the specification and practice of the present invention disclosed herein. It is intended that the specification and examples be considered as exemplary only, with a true scope and spirit of the present invention being indicated by the following claims.

What is claimed is:

1. A method for adjusting display parameters of a display device comprising the steps of:
(A) determining whether an engineering OSD interface is recalled;
(B) adjusting and storing the display parameters displayed on the engineering OSD interface; and
(C) adjusting and storing the display parameters displayed on the user OSD interface;
wherein the engineering OSD interface is recalled by pressing a hot key, and the display parameters include the display parameters displayed on the engineering OSD interface and the user OSD interface.

2. The method for adjusting display parameters of a display device of claim 1, wherein the hot key includes a power button and an adjusting key.

3. The method for adjusting display parameters of a display device of claim 1, wherein the hot key includes a plurality of adjusting keys.

4. A method for adjusting display device parameters of a display device comprising:
(A) recalling a user OSD interface;
(B) determining whether an engineering OSD interface is recalled;
(C) adjusting and storing the display parameters displayed on the user OSD interface; and
(D) adjusting and storing the display parameters displayed on the user OSD interface;
wherein the display device parameters include the manufacturer setting parameters and the user setting parameters.

5. The method for adjusting display parameters of a display device of claim 4, wherein the hot key includes a power button and an adjusting key.

6. The method for adjusting display parameters of a display device of claim 4, wherein the hot key includes a plurality of adjusting keys.
